(19) United States
(12) Patent Application Publication
(10) Pub. No.: US 2020/0259209 A1
(43) Pub. Date: Aug. 13, 2020

(54) ELECTROLTYE AND LITHIUM BATTERY INCLUDING THE ELECTROLYTE

(71) Applicants: Samsung Electronics Co., Ltd., Suwon-si (KR); Samsung SDI Co., Ltd., Yongin-si (KR)

(72) Inventors: Insun PARK, Suwon-si (KR); Myongchun KOH, Hwaseong-si (KR); Dongyoung KIM, Yongin-si (KR); Yoonsok KANG, Seongnam-si (KR); Jinah SEO, Seoul (KR)

(21) Appl. No.: 16/787,126

(22) Filed: Feb. 11, 2020

(30) Foreign Application Priority Data
Feb. 12, 2019 (KR) 10-2019-0016355

(51) Int. Cl. H01M 10/0525; H01M 10/0567; H01M 10/0569

(52) U.S. Cl. CPC H01M 10/0525; H01M 10/0569; H01M 10/0567

(57) ABSTRACT

An electrolyte includes: a lithium salt; a non-aqueous solvent; and an unsaturated compound represented by Formula 2:

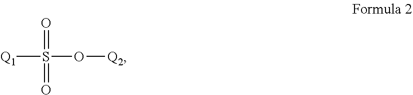

wherein definitions of x, y, z, M, A, Q₁, and Q₂ in Formula 1 and Formula 2 are the same as those described in the description.

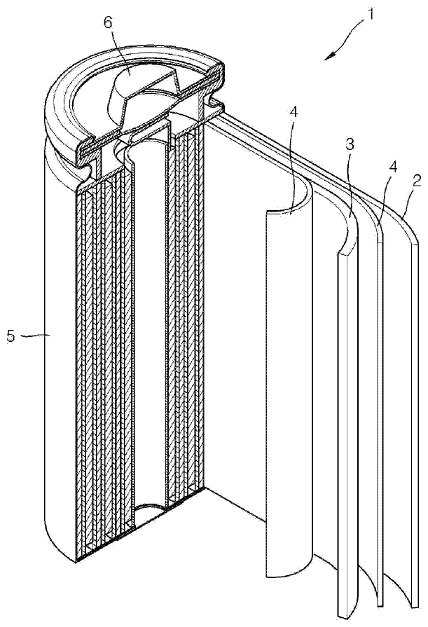

### CROSS-REFERENCE TO RELATED APPLICATION

This application claims priority to and the benefit of Korean Patent Application No. 10-2019-0016355, filed on Feb. 12, 2019, in the Korean Intellectual Property Office, and all benefits accruing therefrom under 35 U.S.C. § 119, the content of which is incorporated herein in its entirety by reference.

### BACKGROUND

### 1. Field

The present disclosure relates to an electrolyte and a lithium battery including the electrolyte.

### 2. Description of the Related Art

A lithium battery is used as power source for driving a portable electronic appliance such as a video camera, a mobile phone, and a notebook computer. A rechargeable lithium secondary battery has, on average, three times greater energy density per unit weight than a lead battery, a nickel-cadmium battery, a nickel metal hydride battery, and a nickel-zinc battery, and may also provide for a possibility be charged at high speed, i.e., at relatively short time of recharge.

To manufacture a lithium second battery having high energy density, a cathode active material providing an increased discharge capacity may be used, however such a cathode active material may have relatively low electrochemical stability. A side reaction between a cathode active material and an electrolyte, which occurs during a charge-discharge process of a lithium secondary battery, may detrimentally impact the stability of the lithium secondary battery. Therefore, there is a need for a method of improving the stability of a lithium secondary battery including a cathode active material with an increase in charge or discharge capacity.

### SUMMARY

Provided is an electrolyte for a lithium battery.

Provided is a lithium battery including the cathode.

Additional aspects will be set forth in part in the description which follows and, in part, will be apparent from the description, or may be learned by practice of the presented embodiments.

According to an embodiment, an electrolyte includes:

a lithium salt;

a non-aqueous solvent; and

an unsaturated compound represented by Formula 2:

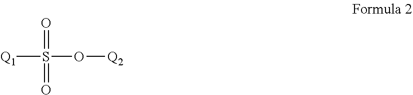

wherein, in Formula 2, one of Q₁ or Q₂ is a group represented by -(L₁)-(R₁), and the other of Q₁ or Q₂ is a group represented by -(L₂)-(R₂),

L₁ is a substituted or unsubstituted C₂-C₂₀ alkenylene group or a substituted or unsubstituted C₂-C₂₀ alkynylene group,

L₂ is a substituted or unsubstituted C₆-C₆₀ arylene group, and R₁ and R₂ are each independently hydrogen, a substituted or unsubstituted C₁-C₃₀ alkyl group, or a substituted or unsubstituted C₆-C₆₀ aryl group, wherein R₁ and R₂ can be the same or different.

According to an aspect of an embodiment, a lithium battery includes:

a cathode;

an anode; and

an electrolyte disposed between the cathode and the anode,

wherein the cathode includes a cathode active material represented by Formula 1, and the electrolyte includes a lithium salt, a non-aqueous solvent, and an unsaturated compound represented by Formula 2:

LiₓNi_{y}M_{1-y}O_{2-z}A_{z} Formula 1

wherein, in Formula 1, 0.9≤x≤1.2, 0.7≤y≤0.98, and 0≤z≤0.2 0≤z≤0.2,

M is at least one of Al, Mg, Mn, Co, Fe, Cr, V, Ti, Cu, B, Ca, Zn, Zr, Nb, Mo, Sr, Sb, W, or Bi, and

A is an element having an oxidation number of −1, −2, or −3; and

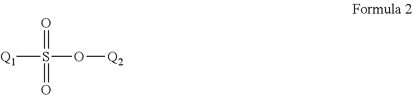

wherein, in Formula 2, one of Q₁ or Q₂ is a group represented by -(L₁)-(R₁), and the other of Q₁ or Q₂ is a group represented by -(L₂)-(R₂),

L₁ is a substituted or unsubstituted C₂-C₂₀ alkenylene group or a substituted or unsubstituted C₂-C₂₀ alkynylene group,

L₂ is a substituted or unsubstituted C₆-C₆₀ arylene group, and

R₁ an linear or branched C₁-C₃₀ alkyl group, or a substituted or unsubstituted C₆-C₆₀ aryl group, wherein R₁ and R₂ can be the same or different.

### BRIEF DESCRIPTION OF THE DRAWING

These and/or other aspects will become apparent and more readily appreciated from the following description of the embodiments, taken in conjunction with FIGURE which is a schematic view of a lithium battery according to an example embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, “a,” “an,” “the,” and “at least one” are do not denote a limitation of quantity, and are intended to cover both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, an organic electrolyte for lithium batteries and a lithium battery employing the organic electrolyte according to example embodiments will be described in more detail.

According to an embodiment, an electrolyte includes:

a lithium salt;

a non-aqueous solvent; and

an unsaturated compound represented by Formula 2:

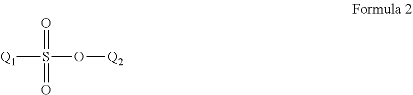

wherein, in Formula 2, one of Q₁ or Q₂ is a group represented by -(L₁)-(R₁), and the other of Q₁ or Q₂ is a group represented by -(L₂)-(R₂),

L₁ is a substituted or unsubstituted C₂-C₂₀ alkenylene group or a substituted or unsubstituted C₂-C₂₀ alkynylene group,

L₂ is a substituted or unsubstituted C₆-C₆₀ arylene group, and

R₁ and R₂ are each independently hydrogen, a substituted or unsubstituted C₁-C₃₀ alkyl group, or a substituted or unsubstituted C₆-C₆₀ aryl group, wherein R₁ and R₂ can be the same or different.

A lithium battery according to an embodiment includes:

a cathode;

an anode; and

an electrolyte disposed between the cathode and the anode,

wherein the cathode includes a cathode active material represented by Formula 1, and the electrolyte includes a lithium salt, a non-aqueous solvent, and an unsaturated compound represented by Formula 2:

LiₓNi_{y}M_{1-y}O_{2-z}A_{z} Formula 1

wherein, in Formula 1, 0.9≤x≤1.2, 0.7≤y≤0.98, and 0≤z≤0.2,

M is at least one of Al, Mg, Mn, Co, Fe, Cr, V, Ti, Cu, B, Ca, Zn, Zr, Nb, Mo, Sr, Sb, W, or Bi, and

A is an element having an oxidation number of −1, −2, or −3; and

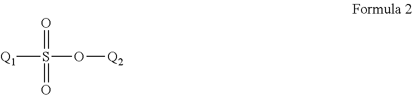

wherein, in Formula 2, one of Q₁ or Q₂ is a group represented by -(L₁)-(R₁), and the other of Q₁ or Q₂ is a group represented by -(L₂)-(R₂),

L₁ is a substituted or unsubstituted C₂-C₂₀ alkenylene group or a substituted or unsubstituted C₂-C₂₀ alkynylene group,

L₂ is a substituted or unsubstituted C₆-C₆₀ arylene group, and

R₁ and R₂ are each independently hydrogen, a substituted or unsubstituted C₁-C₃₀ alkyl group, or a substituted or unsubstituted C₆-C₆₀ aryl group, wherein R1 and R₂ can be the same or different.

In the case of a lithium metal composite oxide having a high Ni content such as the cathode active material represented by Formula 1, a high-power and high-capacity battery may be obtained, however Ni cations within the lithium metal composite oxide elute from the cathode into the electrolyte to cause the deterioration of the cathode. Moreover, the Ni cations can react with a passivation film (solid electrolyte interphase (SEI) film) of the anode to decompose the SEI film and expose a part of the anode active material to the electrolyte, which in turn can cause a side reaction leading to deteriorating capacity characteristics and lifetime characteristics and an increase in gas generation resulting from the side reaction.

To address these technical issues, the lithium battery includes an electrolyte including an unsaturated compound represented by Formula 2. The unsaturated compound is believed to minimize the side reaction caused by the elution of the Ni cations, and thereby reducing gas generation to improve the lifetime of the lithium battery.

It is proposed that the unsaturated compound having a high affinity with Ni cations provides an interaction that is shown to suppress the side reaction caused by the Ni cations. In particular, when the lithium battery is driven under a high voltage, the unsaturated compound maintains high affinity with Ni cations, and thus there is an effect of suppressing the decomposition of the SEI film. Further, the unsaturated compound, which is a material that can be reduced at a metal anode, may form a more stable SEI film on the surface of the anode. Moreover, the unsaturated compound may minimize the decomposition of the electrolyte solvent at the metal anode. The SEI film formed on the surface of the anode reduces the generation of gas, and thereby improving the electrochemical characteristics of the lithium battery. Moreover, the reduction of the unsaturated compound at the anode is thought to improve the stability of the SEI film, and thereby reduce the amount of gas generation of a lithium secondary battery and improve the performance of the lithium battery.

The amount of the unsaturated compound in the electrolyte may be about 5 parts by weight or less per 100 parts by weight of the electrolyte. The amount may not be limited as long as Ni cations eluted from the cathode active material into the electrolyte are stabilized and a protective film is easily formed on the surface of the anode by the unsaturated compound. When the amount of the unsaturated compound is more than 5 parts by weight, the unsaturated compound itself may decompose to a greater extent, which can lead to an increase coating resistance. Moreover, the produced CO₂ from the decomposition of the unsaturated compound can negatively impact battery capacity, storage stability, or charge/discharge cycle characteristics.

According to an embodiment, the amount of the unsaturated compound may be about 0.005 parts by weight to about 5 parts by weight per 100 parts by weight of the electrolyte. For example, the amount of the unsaturated compound may be about 0.01 parts by weight to about 2 parts by weight, or about 0.1 parts by weight to about 1.5 parts by weight per 100 parts by weight of the electrolyte.

When the amount of the unsaturated compound is less than 0.005 parts by weight per 100 parts by weight of the electrolyte, the amount present is too small so the protective film may not form, and a sufficient resistance reduction may not be observed.

According to an embodiment, L₁ is a C₂-C₂₀ aliphatic hydrocarbon groups having at least one double bond. Examples include, but are not limited to, an ethenylene group, a propenylene group, an isobutenylene group, a sec-butenylene group, a ter-butenylene group, a pentenylene group, a 2-pentenylene group, a 3-pentenylene group, a 2,2-dimethylpropenylene group, a 2-methylbutenylene group, a 2-methyl-2-butenylene group, a 3-methylbutenylene group, a 3-methyl-2-butenylene group, a hexenylene group, a 2-hexenylene group, a 3-hexenylene group, a 2-methylpentenylene group, a 2-methyl-2-pentenylene group, a 2-methyl-3-pentenylene group, a 3-methylpentenylene group, a 3-methyl-2-pentenylene group, a 3-methyl-3-pentenylene group, a 4-methylpentenylene group, a 4-methyl-2-pentenylene group, a 3-dimethyl-2-butenylene group, a 3,3-dimethylbutenylene group, a 3,3-dimethyl-2-butenylene group, or a 2-ethylbutenylene group.

In another embodiment, L₁ is a C₂-C₂₀ aliphatic hydrocarbon groups with at least one triple bond. Example include, but not limited to, an ethynylene group, a propynylene group, an isobutynylene group, a sec-butynylene group, a ter-butynylene group, a pentynylene group, a 2-pentynylene group, a 3-pentynylene) group, a 2,2-dimethylpropynylene group, a 2-methylbutynylene group, a 2-methyl-2-butynylene group, a 3-methylbutynylene group, a 3-methyl-2-butynylene group, a hexenylyne group, a 2-hexenylyne group, a 3-hexenylyne group, a 2-methylpentynylene group, a 2-methyl-2-pentynylene group, a 2-methyl-3-pentynylene group, a 3-methylpentynylene group, a 3-methyl-2-pentynylene group, a 3-methyl-3-pentynylene group, a 4-methylpentynylene group, a 4-methyl-2-pentynylene group, a 3-dimethyl-2-butynylene group, a 3,3-dimethylbutynylene group, a 3,3-dimethyl-2-butynylene group, or a 2-ethylbutynylene group.

According to an embodiment, L₂ is a phenylene group, a naphthylene group, a fluorenylene group, a spiro-bifluorenylene group, a benzofluorenylene group, a dibenzofluorenylene group, a phenanthrenylene group, or an anthracenylene group; or a phenylene group, a naphthylene group, a fluorenylene group, a spiro-bifluorenylene group, a benzofluorenylene group, a dibenzofluorenylene group, a phenanthrenylene group, or an anthracenylene group, each of which is substituted with at least one of deuterium, —F, —Cl, —Br, —I, a hydroxyl group, a cyano group, a nitro group, an amidino group, a hydrazino group, a hydrazino group, a C₁-C₃₀ alkyl group, a C₁-C₃₀ alkoxy group, a cyclopentyl group, a cyclohexyl group, a cyclohexenyl group, a phenyl group, a biphenyl group, a terphenyl group, or a naphthyl group.

For example, L₂ may be a phenylene group or a naphthylene group.

According to an embodiment, R₁ and R₂ may each independently be a substituted or unsubstituted linear or branched C₁-C₃₀ alkyl group, or a substituted or unsubstituted C₆-C₆₀ aryl group.

According to another embodiment, R₁ and R₂ may each independently be a phenyl group, a naphthyl group, an anthracenyl group, a biphenyl group, or a terphenyl group; or a phenyl group, a naphthyl group, an anthracenyl group, a biphenyl group, and a terphenyl group, each of which is substituted with at least one of a methyl group, an ethyl group, a propyl group, an isopropyl group, a butyl group, a sec-butyl group, a tert-butyl group, or an isobutyl group.

Examples of the C₁-C₃₀ alkyl group may include, but are not limited to, a methyl group, an ethyl group, a propyl group, an isopropyl group, a butyl group, a sec-butyl group, a tert-butyl group, or an isobutyl group.

Examples of the C₆-C₆₀ aryl group may include, but are not limited to, a phenyl group, a naphthyl group, a biphenyl group, or a terphenyl group.

According to an embodiment, the unsaturated compound may be a compound represented by Formula 3 or Formula 4:

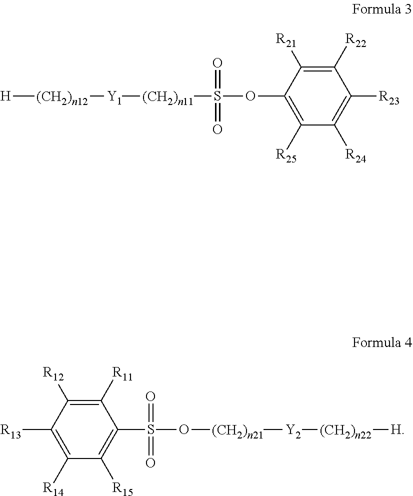

In Formulae 3 and 4,

n11, n12, n21, and n22 are each independently an integer of 0 to 5,

Y₁ and Y₂ are each independently —CH═CH— or —C═C—, and

R₁₁ to R₁₅ and R₂₁ to R₂₅ are each independently hydrogen, a methyl group, an ethyl group, a propyl group, an isopropyl group, a butyl group, a sec-butyl group, a tert-butyl group, or an isobutyl group.

According to an embodiment, in Formula 3 and Formula 4, each of n12 and n22 is 0, and at least one of R₁₁ to R₁₅ and R₂₁ to R₂₅ is a methyl group, an ethyl group, a propyl group, an isopropyl group, a butyl group, a sec-butyl group, a tert-butyl group, or an isobutyl group.

For example, the unsaturated compound is at least one of Compound 1, Compound 2, Compound 3, Compound 4, Compound 5, Compound 6, Compound 7, Compound 8, Compound 9, Compound 10, Compound 11, Compound 12, or Compound 13,

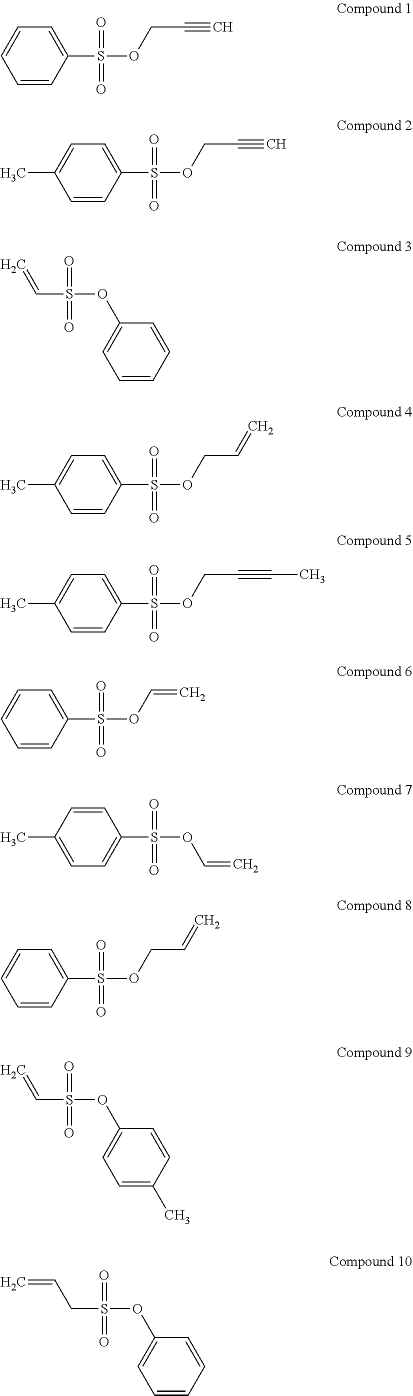

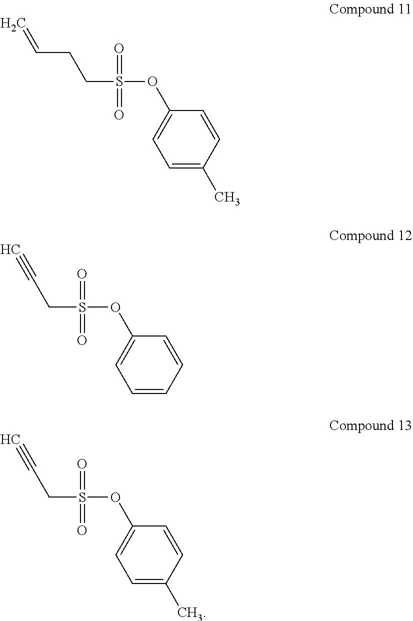

The unsaturated compound represented by Formula 2, which is a sulfonate compound that includes a double bond or a triple bond, can have a high reduction potential, and lead to a reduction in the gas generation of the lithium battery. Further, due to the presence of the unsaturated compound a stable passivation film (solid electrolyte interphase (SEI) film) can form on the surface of the anode to protect the anode, and the lifetime characteristics of the lithium battery may be improved.

The electrolyte includes a lithium salt. The lithium salt may be dissolved in an organic solvent, may act as a supply source of lithium ions in the lithium battery, and for example, may promote the migration of lithium ions between the cathode and the anode.

The anion of the lithium salt included in the electrolyte include at least one of PF₆_{^{−}}, BF₄_{^{−}}, SbF₆_{^{−}}, AsF₆_{^{−}}, C₄F₉SO₃_{^{−}}, ClO₄_{^{−}}, AlO₂_{^{−}}, AlCl₄_{^{−}}, CₓF₂ₓ₊₁SO₃_{^{−}} (where x is a natural number), (CₓF₂ₓ₊₁SO₂)(C_{y}F_{2y+1}SO₂)N⁻ (where x and y are natural numbers), or halide.

The lithium salt included in the electrolyte may include at least one of LiPF₆, LiBF₄, LiCF₃SO₃, Li(CF₃SO₂)₂N, LiC₂F₅SO₃, Li(FSO₂)₂N, LiC₄F₉SO₃, LiN(SO₂CF₂CF₃)₂, a compound represented by Formula 22, a compound represented by Formula 23, a compound represented by Formula 24 or a compound represented by Formula 25.

The lithium salt included in the electrolyte may include at least one of LiPF₆, LiBF₄, LiCF₃SO₃, Li(CF₃SO₂)₂N, LiC₂F₅SO₃, Li(FSO₂)₂N, LiC₄F₉SO₃, or LiN(SO₂CF₂CF₃)₂; and at least one compound represented by Formula 22, Formula 23, Formula 24, or Formula 25 below.

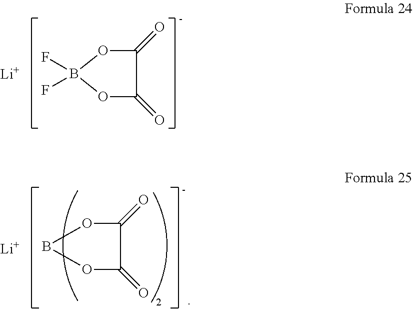

The concentration of the lithium salt may be about 0.01 moles per liter (M) to about 5.0 M, about 0.05 M to about 5.0 M, about 0.1 M to about 5.0 M, or about 0.1 M to about 2.0 M, but is not limited to these ranges. Appropriate concentrations may be used as needed.

The amount of the lithium salt in a solvent-free electrolyte may be about 0.001 parts by weight to about 30 parts by weight, or about 0.05 parts by weight to about 15 parts by weight, about 0.1 parts by weight to about 8 parts by weight, per 100 parts by weight of the solvent-free electrolyte, but is not limited to these ranges. The amount thereof is not limited as long as the electrolyte may effectively transfer lithium ions and/or electrons during a charge-discharge process.

The amount of the lithium salt in a solvent-containing electrolyte may be about 100 millimoles per liter (mM) to about 10 M. For example, the amount thereof may be about 100 mM to about 2 M. For example, the amount thereof may be about 500 mM to about 2 M. However, the amount thereof is not limited to these ranges. The amount thereof is not limited as long as the electrolyte may effectively transfer lithium ions and/or electrons during a charge-discharge process.

According to an embodiment, the concentration of the lithium salt in the electrolyte may be about 1.1 M to about 2.5 M. For example, the concentration of the lithium salt may be about 1.15 M to about 2.2 M, or about 1.3 M to about 2 M.

The non-aqueous solvent may be a carbonate-based solvent, an ester-based solvent, an ether-based solvent, a ketone-based solvent, a nitrile-based solvent, an aprotic solvent and mixtures thereof.

As the carbonate-based solvent, dimethyl carbonate (DMC), diethyl carbonate (DEC), ethyl methyl carbonate (EMC), dipropyl carbonate (DPC), methyl propyl carbonate (MPC), ethyl propyl carbonate (EPC), methyl ethyl carbonate (EC), propylene carbonate (PC), butylene carbonate (BC), or tetraethylene glycol dimethyl ether (TEGDME) may be used. As the ester-based solvent, methyl acetate, ethyl acetate, n-propyl acetate, dimethylacetate, methyl propionate (MP), ethyl propionate, γ-butyrolactone, decanolide, valerolactone, mevalonolactone, or caprolactone may be used. As the ether-based solvent, dibutyl ether, tetraglyme, diglyme, dimethoxyethane, 2-methyltetrahydrofuran, or tetrahydrofuran may be used. As the ketone-based solvent, cyclohexanone may be used. As the nitrile-based solvent, acetonitrile (AN), succinonitrile (SN), or adiponitrile may be used.

The aprotic solvent may be used alone or in a mixture of two or more. When the aprotic solvent is used in a mixture of two or more, the mixing ratio may be appropriately adjusted depending on battery performance, which is obvious to those skilled in the art.

As other solvents, dimethylsulfoxide, dimethylformamide, dimethylacetamide, tetrahydrofuran, and the like may be used, but examples of the other solvents are not limited thereto. Any suitable solvent may be.

For example, the non-aqueous solvent may include about 50 volume percent (vol %) to about 95 vol % of a chain carbonate and about 5 vol % to about 50 vol % of cyclic carbonate, about 55 vol % to about 95 vol % of a chain carbonate and about 5 vol % to about 45 vol % of a cyclic carbonate, about 60 vol % to about 95 vol % of a chain carbonate and about 5 vol % to about 40 vol % of a cyclic carbonate, about 65 vol % to about 95 vol % of a chain carbonate and about 5 vol % to about 35 vol % of a cyclic carbonate, or about 70 vol % to about 95 vol % of a chain carbonate and about 5 vol % to about 30 vol % of a cyclic carbonate. For example, the non-aqueous solvent may be a mixed solvent of three or more kinds of non-aqueous solvents.

In one or more embodiments, the non-aqueous solvent may further include fluoro-ethylene carbonate (FEC), vinylene carbonate (VC), vinyl ethylene carbonate (VEC), a phosphorus (P)-containing compound, or a sulfur (S)-containing compound.

For example, the non-aqueous solvent may include fluoro-ethylene carbonate (FEC). For example, the lithium secondary battery may include the FEC in an amount of about 0.1 vol % to about 10 vol % based on the total volume of the non-aqueous solvent. For example, the lithium secondary battery may include the FEC in an amount of about 0.5 vol % to about 7 vol % based on the total volume of the non-aqueous solvent. For example, the lithium secondary battery may include the FEC in an amount of about 1 vol % to about 7 vol % based on the total volume of the non-aqueous solvent. For example, the lithium secondary battery may include the FEC in an amount of about 2 vol % to about 7 vol % based on the total volume of the non-aqueous solvent. When the FEC is included in the non-aqueous solvent within the above ranges, an effective SEI film that does not inhibit the diffusion speed of lithium ions may be rapidly formed.

According to an embodiment, the non-aqueous solvent may be dimethyl carbonate (DMC), diethyl carbonate (DEC), ethyl methyl carbonate (EMC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), methyl propionate (MP), ethyl propionate (EP), propyl propionate (PP), tetraethylene glycol dimethyl ether (TEGDME), or a combination thereof.

The electrolyte may include a carbonate containing a carbon-carbon single or multiple bond, a carboxylic acid anhydride containing a carbon-carbon single or multiple bond, or a mixture thereof. The multiple bond may be a double bond or a triple bond, and the carbonate and the carboxylic acid anhydride may be linear or cyclic.

According to an embodiment, the electrolyte may include a cyclic carbonate compound, a cyclic acid anhydride compound, a phosphorus (P)-containing compound, a sulfur (S)-containing compound, or a combination thereof.

According to an embodiment, the electrolyte may include a cyclic carbonate compound, a cyclic acid anhydride compound, or a combination thereof.

In many instances, the reduction potential of the unsaturated compound is greater than the reduction potential of the cyclic carbonate compound or the cyclic acid anhydride compound.

According to an embodiment, the amount of the cyclic carbonate compound, the cyclic acid anhydride compound or the mixture thereof may be about 0.1 parts by weight to about 2 parts by weight per 100 parts by weight of the electrolyte.

The cyclic carbonate compound may be, for example, at least one of fluoro-ethylene carbonate (FEC), vinylene carbonate (VC), or vinyl ethylene carbonate (VEC).

The cyclic acid anhydride compound may be, for example, at least one of maleic anhydride or succinic anhydride.

The P-containing compound may be, for example, at least one selected from a phosphine compound, a phosphate compound, or a phosphite compound.

Examples of the phosphine compound may include, but are not limited to, triphenylphosphine or tris(4-fluorophenyl)phosphine, tris(2,4-difluorophenyl)phosphine, or tris(perfluorophenyl)phosphine. Examples of the phosphate compound may include, but are not limited to, triphenyl phosphate (TPPa) and trimethyl phosphate (TMPa). Examples of the phosphite compound may include, but are not limited to, triethylphosphite (TEPi), trimethylphosphite, tripropylphosphite, tributylphosphite, tris (trimethylsilyl) phosphite, or triphenylphosphite.

The S-containing compound may be, for example, at least one of a sulfone compound, a sulfonate compound, a sulfone compound, and a disulfonate compound.

Examples of the sulfone compound may include, but are not limited to, ethyl methyl sulfone, divinyl sulfone, or tetramethylene sulfone. Examples of the sulfonate compound may include, but are not limited to, methyl methane sulfonate, ethyl methane sulfonate, or diallyl sulfonate. Examples of the disulfonate compound may include, but are not limited to, methylene methane disulfonate (MMDS) or busulfan. Examples of the sultone compound may include, but are not limited to, fluoropropane sultone (FPS).

According to an embodiment, the electrolyte may be included in the lithium battery in an amount of about 1 gram per ampere-hours (g/Ah) to about 3 g/Ah.

The cathode includes a cathode active material represented by Formula 1 above.

For example, in Formula 1, A may be any one halogen, S, or N, but is not limited thereto.

In Formula 1, y indicates the amount of Ni in the cathode active material.

Further, according to an embodiment, in Formula 1, M may be at least one element of Co, Al, or Mn.

For example, the cathode may include at least one of Li_{1.02}Ni_{0.80}Co_{0.15}Mn_{0.05}O₂, Li_{1.02}Ni_{0.85}Co_{0.1} Mn_{0.05}O₂, Li_{1.02}Ni_{0.88}Co_{0.08}Mn_{0.04}O₂, Li_{1.02}Ni_{0.88}Co_{0.10}Mn_{0.02}O₂, Li_{1.02}Ni_{0.91}Co_{0.06}Mn_{0.03}O₂, LiNi_{0.94}Co_{0.04}Mn_{0.02}O₂, Li_{1.02}Ni_{0.80}Co_{0.15}Al_{0.05}O₂, Li_{1.02}Ni_{0.85}Co_{0.1}Al_{0.05}O₂, Li_{1.02}Ni_{0.88}Co_{0.08}Al_{0.04}O₂, Li_{1.02}Ni_{0.88}Co_{0.10}Al_{0.02}O₂, Li_{1.02}Ni_{0.91}Co_{0.06}Al_{0.03}O₂, or LiNi_{0.94}Co_{0.04}Al_{0.02}O₂.

According to an embodiment, in Formula 1, y may satisfy 0.88≤y≤0.98.

For example, the cathode active material may be represented by Formula 30 or Formula 40.

Li_{x′}Ni_{y′}Co_{1-y′-z′}Al_{z′}O₂ Formula 30

Li_{x′}Ni_{y′}Co_{1-y′-z′}Mn_{z′}O₂ Formula 40

In Formulae 30 and 40, 0.9≤x′≤1.2, 0.88≤y′≤0.98, 0<z″<0.1, and 0<1-y″-z″<0.2.

For example, the cathode may include at least one of Li_{1.02}Ni_{0.80}Co_{0.15}Mn_{0.05}O₂, Li_{1.02}Ni_{0.85}Co_{0.1}Mn_{0.05}O₂, Li_{1.02}Ni_{0.88}Co_{0.08}Mn_{0.04}O₂, Li_{1.02}Ni_{0.88}Co_{0.10}Mn_{0.02}O₂, Li_{1.02}Ni_{0.91}Co_{0.06}Mn_{0.03}O₂, LiNi_{0.94}Co_{0.04}Mn_{0.02}O₂, Li_{1.02}Ni_{0.80}Co_{0.15}Al_{0.05}O₂, Li_{1.02}Ni_{0.85}Co_{0.1}Al_{0.05}O₂, Li_{1.02}Ni_{0.88}Co_{0.08}Al_{0.04}O₂, Li_{1.02}Ni_{0.88}Co_{0.10}Al_{0.02}O₂, Li_{1.02}Ni_{0.91}Co_{0.06}Al_{0.03}O₂, or LiNi_{0.94}Co_{0.04}Al_{0.02}O₂.

As described above, if a lithium metal oxide has a relatively high content of Ni for the advantage of realizing high-capacity batteries, there is a disadvantage of lifetime characteristics being deteriorated with the increase of the amount of Ni³⁺ cations.

Further, as will be described later, a lithium battery including an anode active material including a metal alloyable with lithium or a carbon anode active material can have a technical disadvantage of gas generation by catalysis at high temperature, and the consequent deterioration of lifetime characteristics due to the gas generation.

As described above, when FEC, VC, VEC, MA, SA, the phosphorus (P)-containing compound, or the sulfur (S)-containing compound is included in the above range, a surface passivation of the anode that can include a chemical reaction product of these materials can occur, that is, an SEI film may be formed on a part or all of the surface of the anode. In this case, since the unsaturated compound includes a double bond or a triple bond and a relatively high reduction potential, the unsaturated compound is reduced prior to one or more solvent compounds, e.g., FEC, and, a strong SEI film capable of capturing Ni cations eluted from the cathode can form. As a result, gas generation may be minimized during high-temperature storage, thereby providing an improvement of stability and performance of the lithium battery.

Further, the cathode may further include at least one of lithium cobalt oxide, lithium nickel cobalt manganese oxide, lithium nickel cobalt aluminum oxide, lithium iron oxide, or lithium manganese oxide in addition to the above-described cathode active material. However, the present disclosure is not limited thereto, and the cathode may further include all of the cathode active materials available in the art.

The anode may include an anode active material. The anode active material may include at least one of a silicon compound, a carbon compound, a composite of a silicon compound and a carbon compound, and a silicon oxide (SiOₓ₁, 0×12). For example, the anode may include an anode active material including a metal alloyable with lithium, a silicon anode active material, and/or a carbon anode active material.

For example, the silicon compound includes silicon particles with an average diameter of the silicon particles of about 10 nanometers (nm) to about 200 nm.

For example, the carbon compound may include graphite.

For example, a composite of a silicon compound and a carbon compound may be a composite having a structure in which silicon nanoparticles are arranged on a carbon compound, a composite having a structure in which silicon particles are included on the surface of the carbon-base compound and inside the carbon compound, or a composite having a structure in which silicon particles are coated with the carbon compound and included inside the carbon compound. The composite of a silicon compound and a carbon compound may be an active material obtained by dispersing silicon nanoparticles having an average particle diameter of about 5 micrometers to about 200 nm on carbon compound particles and then carbon-coating the resulting particles, or an active material in which silicon particles exist on graphite and/or inside graphite. The average particle diameter of secondary particles of the composite of the silicone compound and the carbon compound is about 5 μm to about 20 μm, and the average particle diameter of the silicon nanoparticles may be 200 nm or less, 150 nm or less, 100 nm or less, 50 nm or less, 20 nm or less, 10 nm or less. For example, the average particle diameter of the silicon nanoparticles may be about 100 nm to about 150 nm.

For example, the capacity of the composite of the silicone compound and the carbon compound may be about 300 milliampere-hours per gram (mAh/g) to about 700 mAh/g. For example, the capacity of the composite of the silicone compound and the carbon compound may be about 400 mAh/g to about 600 mAh/g.

The capacity retention rate of the lithium battery at 25° C. after 200 cycles of charging and discharging may be 75% or greater, for example, 80% or greater or 82% or greater. For example, when the anode of the lithium battery includes a silicon compound or a silicon oxide, the capacity retention rate of the lithium battery at 25° C. after 200 cycles of charging and discharging may be 85% or v.

The DCIR increase rate of the lithium battery at 25° C. after 200 cycles of charging and discharging may be about 100% to about 180%. For example, when the anode of the lithium battery includes a silicon compound or a silicon oxide, the DCIR increase rate of the lithium battery at 25° C. after 200 cycles of charging and discharging may be 150% or less, for example, 120% or less.

The cell energy density of the lithium battery per unit cell volume may be 500 Watt-hours per liter (Wh/L) or greater, or about 600 Wh/L or greater, or about 750 Wh/L or greater, or about 500 Wh/L to about 900 Wh/L. The lithium battery may provide a high output by providing a high energy density of 500 Wh/L or greater.

The lithium battery is not limited in form, and includes a lithium ion battery, a lithium ion polymer battery, and a lithium sulfur battery.

The lithium secondary battery according to an embodiment may be manufactured by the following method.

First, a cathode is prepared.

For example, a cathode active material composition in which a cathode active material, a conductive agent, a binder, and a solvent are mixed is prepared. The cathode is prepared by coating a cathode current collector with the cathode active material composition. Alternatively, the cathode may be prepared by casting the cathode active material composition onto a separate support, separating a film from the support and then laminating the separated film on a metal current collector. The cathode is not limited to the above-described form, but may have a form other than the above-described form.

The cathode active material may include a general lithium-containing metal oxide in addition to the cathode active material represented by Formula 1 above. As the lithium-containing metal oxide, for example, two or more kinds of composite oxides of lithium and a metal cobalt, manganese, nickel, or combinations thereof may be used.

For example, the cathode active material may further include a compound represented by at least one of LiₐA_{1-b}B′_{b}D₂ (where 0.90≤a≤1.8 and 0≤b≤0.5); LiₐE_{1-b} B′_{b}O_{2-c}D_{c} (where 0.90≤a≤1.8, 0≤b≤0.5, and 0≤c≤0.05); LiE_{2-b}B′_{b}O_{4-c}D_{c} (where 0≤b≤0.5 and 0≤c≤0.05); LiₐNi_{1-b-c}Co_{b}B′_{c}D_{α} (where 0.90≤a≤1.8, 0≤b≤0.5, 0≤c≤0.05, and 0<α≤2); LiₐNi_{1-b-c}Co_{b}B′_{c}O_{2-α}T_{α} (where 0.90≤a≤1.8, 0≤b≤0.5, 0≤c≤0.05, and 0<α<2); LiₐNi_{1-b-c}Co_{b}B′_{c}O_{2-α}T₂ (where 0.90≤a≤1.8, 0≤b≤0.5, 0≤c≤0.05, and 0<α<2); LiₐNi_{1-b-c}Mn_{b}B′_{c}D_{α} (where 0.90≤a≤1.8, 0≤b≤0.5, 0≤c≤0.05, and 0<α≤2); LiₐNi_{1-b-c}Mn_{b}B′_{c}O_{2-α}F_{α} (where 0.90≤a≤1.8, 0≤b≤0.5, 0≤c≤0.05, and 0<α<2); LiₐNi_{1-b-c}Mn_{b}B′_{c}O_{2-α}F₂ (where 0.90≤a≤1.8, 0≤b≤0.5, 0≤c≤0.05, and 0<α<2); LiₐNi_{b}E_{c}G_{d}O₂ (where 0.90≤a≤1.8, 0≤b≤0.9, 0≤c≤0.5, and 0.001≤d≤0.1); LiₐNi_{b}Co_{c}Mn_{d}GₑO₂ (where 0.90≤a≤1.8, 0≤b≤0.9, 0≤c≤0.5, 0≤d≤≤0.5, and 0.001≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂G_{b}O₄ (where 0.90≤a≤1.8 and 0.001≤b≤0.1); QO₂; QS₂; LiQS₂; V₂O₅; LiV₂O₅; LII′O₂; LiNiVO₄; Li_{(3-f)}J₂(PO₄)₃(0≤f≤2); Li_{(3-f)}Fe₂(PO₄)₃(0≤f≤2); or LiFePO₄.

In the formulae above, A is Ni, Co, Mn, or a combination thereof; B′ is Al, Ni, Co, Mn, Cr, Fe, Mg, Sr, V, a rare earth element, or a combination thereof; D is O, F, S, P, or a combination thereof; E is Co, Mn, or a combination thereof; T is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; and J is V, Cr, Mn, Co, Ni, Cu, or a combination thereof.

For example, the compound may be LiCoO₂, LiMnₓO₂ₓ (where x=1 or 2), LiNi₁₋ₓMnₓO₂ₓ (where 0<x<1), LiNi_{1-x-y}CoₓMn_{y}O₂ (where 0≤x≤0.5, 0≤y≤0.5, and 1-x-y>0.5), or LiFePO₄.

In one or more embodiments, a compound having a coating layer on the surface of the compound may be used, or a mixture of the compound and a compound having a coating layer may be used. This coating layer may include a coating element compound of an oxide of a coating element, a hydroxide of a coating element, an oxyhydroxide of a coating element, an oxycarbonate of a coating element, or a hydroxycarbonate of a coating element. The compound constituting this coating layer may be amorphous or crystalline.

As the coating element included in the coating layer, Mg, Al, Co, K, Na, Ca, Si, Ti, V, Sn, Ge, Ga, B, As, Zr, or a mixture thereof may be used. In the process of forming the coating layer, any coating method may be used as long as this compound may be coated with such elements by a method that does not adversely affect the physical properties of the cathode active material (for example, spray coating, dipping or the like). This coating method will be understood by those skilled in the art, so that a detailed description thereof will be omitted.

A conductive agent, a filler, and the like may be further added to the cathode active material composition. The conductive agent is usually added in an amount of 1 wt % to 30 wt % based on the total weight of the mixture including the cathode active material. Such a conductive agent is not limited as long as it has electrical conductivity without causing a chemical change in the battery, and examples thereof may include graphite such as natural graphite or artificial graphite; carbon black, acetylene black, ketjen black, channel black, furnace black, lamp black, and summer black; conductive fibers such as carbon fiber or metal fiber; carbon fluoride; metal powder such as aluminum powder or nickel powder; conductive whiskers such as zinc oxide or potassium titanate; conductive metal oxides such as titanium oxide; or conductive agents such as polyphenylene derivatives.

The binder is a component that assists in binding of the active material and the conductive agent and binding of the active material to the current collector, and is added in an amount of about 1 wt % to about 30 wt % based on the total weight of the cathode active material composition. Examples of the binder may include polyvinylidene fluoride (PVdF), polyvinylidene chloride, polybenzimidazole, polyimide, polyvinyl acetate, polyacrylonitrile, polyvinyl alcohol, carboxymethylcellulose (CMC), starch, hydroxypropylcellulose, regenerated cellulose, polyvinylpyrrolidone, polyethylene, polypropylene, polystyrene, polymethyl methacrylate, polyaniline, acrylonitrile butadiene styrene resin, phenol resin, epoxy resin, polyethylene terephthalate, polytetrafluoroethylene, polyphenylene sulfide, polyamideimide, polyetherimide, polyether sulfone, polyamide, polyacetal, polyphenylene oxide, polybutylene terephthalate, ethylene-propylene-diene terpolymer (EPDM), sulfonated EPDM, styrene butadiene rubber (SBR), fluorine rubber, or a copolymer thereof. The filler is a component for suppressing the expansion of the cathode, is selectively used, is not limited as long as it is a fibrous material not causing a chemical change in the battery, and examples thereof may include olefin polymers such as polyethylene or polypropylene; and fibrous materials such as glass fiber or carbon fiber.

As the solvent, N-methylpyrrolidone, acetone, water, or the like may be used, but not limited thereto, and any solvent which may be used in the technical field may be used. The amount of the solvent is, for example, 10 parts by weight to 100 parts by weight based on 100 parts by weight of the cathode active material. When the amount of the solvent is within the above range, it is easy to form an active material layer.

The amount of the cathode active material, the amount of the conductive agent, the amount of the filler, and the amount of the solvent are levels commonly used in the lithium battery. At least one of the conductive agent, the filler, the binder and the solvent may be omitted depending on the use and configuration of the lithium battery.

For example, N-methylpyrrolidone (NMP) may be used as the solvent, a PVdF or PVdF copolymer may be used as the binder, and carbon black or acetylene black may be used as the conductive agent. For example, 94 weight % (wt %) of the cathode active material, 3 wt % of the binder, and 3 wt % of the conductive agent are mixed in a powder state, NMP is added such that solid content is 70 wt % to make a slurry, and then, the prepared slurry is coated, dried, and rolled to manufacture the cathode.

The cathode current collector is generally manufactured to have a thickness of about 3 μm to about 50 μm. This cathode current collector is not limited as long as it has high conductivity without causing a chemical change in the battery. For example, the cathode current collector may include stainless steel, aluminum, nickel, titanium, or fired carbon, or may include aluminum or stainless steel surface-treated with carbon, nickel, titanium or silver. The cathode current collector may form fine irregularities on its surface to increase the adhesive force of the cathode active material, and may various forms such as film, sheet, foil, net, porous body, foam, or nonwoven fabric.

For example, the cathode is produced by applying, drying and pressing a cathode active material on a cathode current collector, and a cathode active material composition in which a binder is mixed with a solvent is prepared as needed in addition to the above-described active material. The cathode active material composition is directly applied on a metal current collector and dried to produce a cathode plate. Alternatively, the cathode active material composition is cast onto a separate support, a film is separated from the support, and then the separated film is laminated on a metal current collector to produce a cathode plate.

For example, the loading level of the produced cathode active material may be about 30 milligram per square centimeter (mg/cm²) or greater, for example, 35 mg/cm² or greater, and for example, 40 mg/cm² to about 400 mg/cm². Further, electrode density may be 3 grams per cubic centimeter (g/cc) or greater, for example, 3.5 g/cc greater.

In an embodiment, for high cell energy density, the loading level of the produced cathode active material may be about 35 mg/cm² to about 50 mg/cm², and the electrode density may be about 3.5 g/cc to about 4.2 g/cc.

In another embodiment, both sides of the cathode plate may be coated with the cathode active material composition at a loading level of 37 mg/cm² and an electrode density of 3.6 g/cc

When the loading level of the cathode active material and the electrode density satisfy the above ranges, a battery including this cathode active material may exhibit a high cell energy density of 500 Wh/L or greater, or about 600 Wh/L or greater, or about 750 Wh/L or greater. For example, the battery may exhibit a cell energy density of about 500 Wh/L to about greater Wh/L.

Next, an anode is prepared.

For example, an anode active material composition in which an anode active material, a conductive agent, a binder, and a solvent are mixed is prepared.

The anode is prepared by directly coating an anode current collector with the anode active material composition and drying the anode active material composition. Alternatively, the anode may be prepared by casting the anode active material composition onto a separate support, separating a film from the support and then laminating the separated film on a metal current collector.

The anode active material may be, for example, a silicon-based compound, silicon oxide (SiOₓ, 0<x<2), or a composite of a silicon-based compound and a carbon-based material. Here, the size (for example, average particle diameter) of silicon particles may be less than about 200 nm, or less than about 150 nm, or less than about 50 nm, or less than about 25 nm, for example, about 1 nm to about 200 nm, or about 10 nm to about 150 nm, or about 10 nm to about 75 nm. The term “size” may refer to an average particle diameter when the silicon particles are spherical and may refer to an average long axis length when the silicon particles are non-spherical.

When the size of the silicon particles is within the above range, lifetime characteristics are good, and thus the lifetime of a lithium secondary battery is further improved when the electrolyte according to an embodiment is used.

The carbon-based material may be crystalline carbon, amorphous carbon, or a mixture thereof. The crystalline carbon may be graphite such as natural graphite or artificial graphite of an amorphous, plate-like, flake-like, spherical or fibrous form. The amorphous carbon may be soft carbon (low-temperature fired carbon), hard carbon, mesophase pitch carbide, or fired coke.

The composite of a silicon-based compound and a carbon-based material may be a composite having a structure in which silicon particles are disposed on graphite, or a composite having a structure in which silicon particles are disposed on the surface of the graphite and on the inside of the graphite. The composite may be, for example, an active material in which silicon (Si) particles having an average particle diameter of 200 nm or less, for example, about 100 nm to about 200 nm, and for example, 150 nm are dispersed on graphite particles and then coated with carbon, or an active material in which silicon (Si) particles are present on a surface of the graphite and inside of the graphite. Such a silicon-graphite composite is available as the trade name SCN1 (Si particle on graphite) or SCN2 (Si particle inside and on graphite). SCN1 may be an active material obtained by dispersing Si particles having an average particle diameter of about 150 nm on graphite particles and then further coating the surface of the Si particles with carbon. SCN2 is an active material in which silicon (Si) particles having an average particle diameter of about 150 nm are present on a surface of the graphite and inside of the graphite.

The anode active material may be used together with the above-described anode active material as long as it may be used as the anode active material of a lithium secondary battery in the related art. For example, the anode active material may be Si, Sn, Al, Ge, Pb, Bi, Sb, a Si—Y′ alloy (Y′ is an alkali metal, an alkaline earth metal, a Group 13 to Group 16 element, a transition metal, a transition metal oxide, a rare earth element, or combinations thereof, not Si), or a Sn—Y′ alloy (Y′ is an alkali metal, an alkaline earth metal, a Group 13 to Group 16 element, a transition metal, a transition metal oxide, a rare earth element, or combinations thereof). The element Y′ may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof.

For example, the anode active material may be lithium titanium oxide, vanadium oxide, or lithium vanadium oxide.

A conductive agent, a filler, and the like may be further added to the anode active material composition.

Meanwhile, the binder, solvent, conductive agent and filler in the anode active material composition may be the same as those in the above-described cathode active material composition.

However, in the anode active material composition, water may be used as the solvent. For example, water may be used as the solvent, carboxymethyl cellulose (CMC), styrene butadiene rubber (SBR), an acrylate polymer, or a methacrylate polymer may be used as the binder, and carbon black, acetylene black, or graphite may be used as the conductive agent.

The amount of the anode active material, the amount of the conductive agent, the amount of the binder, and the amount of the solvent are levels commonly used in the lithium secondary battery. At least one of the conductive agent, the binder, and the solvent may be omitted depending on the use and configuration of the lithium secondary battery.

For example, 94 wt % of the anode active material, 3 wt % of the binder, and 3 wt % of the conductive agent are mixed in a powder state, water is added such that solid content is 70 wt % to make a slurry, and then, the prepared slurry is coated, dried, and rolled to manufacture an anode plate.

The anode current collector is generally manufactured to have a thickness of about 3 μm to about 50 μm. This anode current collector is not limited as long as it has high conductivity without causing a chemical change in the battery. For example, the anode current collector may include copper, stainless steel, aluminum, nickel, titanium, or fired carbon, may include copper or stainless steel surface-treated with carbon, nickel, titanium or silver, or may include an aluminum-cadmium alloy. Similarly to the cathode current collector, the anode current collector may form fine irregularities on its surface to increase the adhesive force of the anode active material, and may various forms such as film, sheet, foil, net, porous body, foam, or nonwoven fabric.

The loading level of the prepared anode active material composition is set according to the loading level of the cathode active material composition.

For example, the loading level of the anode active material composition may be about 12 mg/cm² or greater, for example, about 15 mg/cm² to about 100 mg/cm², depending on the capacity of the anode active material composition per g. Further, electrode density may be about 1.5 g/cc or greater, for example, about 1.6 g/cc to about 10 g/cc.

In an embodiment, for high cell energy density, the loading level of the produced anode active material may be about 15 mg/cm² to about 25 mg/cm², and the electrode density may be about 1.6 g/cc to about 2.3 g/cc.

When the loading level of the anode active material and the electrode density satisfy the above ranges, a battery including this cathode active material may exhibit a high cell energy density of about 500 Wh/L or greater.

Next, a separator to be inserted between the anode and the cathode is prepared.

As the separator, any separator may be used as long as it is commonly used in a lithium battery. A separator having low resistance to the movement of ions in the electrolyte and superior in electrolyte wettability may be used. For example, the separator may include at least one of glass fiber, polyester, Teflon, polyethylene, polypropylene, polytetrafluoroethylene (PTFE), and combinations thereof, and may be made in the form of nonwoven fabric or woven fabric. For example, a windable separator including polyethylene, polypropylene, or the like may be used in a lithium ion battery, and a separator having good electrolyte impregnation ability may be used in a lithium ion polymer battery. For example, the separation film may be produced by the following method.

A polymer resin, a filler, and a solvent are mixed to prepare a separator composition. The separator composition is directly applied on an electrode and dried to form a separator. Further, the separator composition is cast on a support and dried, a separation film is separated from the support, and then the separation film is laminated on the electrode to form a separator.

The polymer resin used in the production of the separator is not limited, and any material may be used as long as it may be used in a binder of an electrode plate. For example, as the polymer resin, a vinylidene fluoride/hexafluoropropylene copolymer, polyvinylidene fluoride (PVDF), polyacrylonitrile, polymethyl methacrylate, or a mixture thereof may be used.

Next, the above-described electrolyte is prepared.

According to an embodiment, in addition to the above-described electrolyte, a non-aqueous electrolyte, a solid electrolyte, an organic solid electrolyte, or an inorganic solid electrolyte may be used.

As the organic solid electrolyte, for example, a polyethylene derivative, a polyethylene oxide derivative, a polypropylene oxide derivative, a phosphate ester polymer, a polyester sulfide, a polyvinyl alcohol, a polyvinylidene fluoride, or a polymer including an ionic dissociation group may be used.

As the inorganic solid electrolyte, for example, Li₃N, LiI, Li₅NI₂, Li₃N—LiI—LiOH, LiSiO₄, Li₂SiS₃, Li₄SiO₄, Li₄SiO₄—LiI—LiOH, or Li₃PO₄—Li₂S—SiS₂ may be used.

As shown in the FIGURE, the lithium secondary battery 1 includes a cathode 3, an anode 2, and a separator 4. The anode 3, the cathode 2, and the separator 4 are wound or folded and accommodated in a battery case 5. Then, an electrolyte is injected into the battery case 5, and the battery case 5 is sealed with a cap assembly 6 to complete the manufacture of the lithium secondary battery 1. The battery case 5 may have a cylindrical shape, a rectangular shape, or a thin film shape. For example, the lithium secondary battery 1 may be a large-sized thin-film battery. The lithium secondary battery 1 may be a lithium ion battery.

The separator is disposed between the anode and the cathode to form a battery structure. The battery structure is laminated as a bi-cell structure and then impregnated with an electrolyte, and the resulting product is accommodated in a pouch and sealed to complete a lithium ion polymer battery.

Further, a plurality of battery structures are laminated to form a battery pack, and this battery pack may be used in all appliances requiring high capacity and high power. For example, the battery pack may be used in notebooks, smart phones, electric vehicles, and the like.

The lithium secondary battery according to an embodiment significantly reduces a DCIR increase rate as compared with a lithium secondary battery employing a general nickel-rich lithium-nickel composite oxide as a cathode active material, and thus may exhibit good battery characteristics.

The operating voltage of the lithium secondary battery to which the anode, the cathode and the electrolyte are applied is, for example, about 2.5 volts (V) to about 2.8 V as a lower limit and about 4.1 V to about 4.4 V as an upper limit, and energy density is 500 Wh/L or greater.

Further, the lithium secondary battery may be used in, for example, power tools operated by a power from an electric motor; electric vehicles including a hybrid electric vehicle (HEV) and a plug-in hybrid electric vehicle (PHEV); electric motorcycles including an electric bike (E-bike) and an electric scooter (E-scooter); electric golf carts; and power storage systems, but the present disclosure is not limited thereto.

As used herein, “alkyl” refers to a saturated, monovalent branched or unbranched (or straight or linear) hydrocarbon. Alkyl groups include, for example, groups having from 1 to 50 carbon atoms (C1 to C50 alkyl) unless otherwise indicated.

Non-limiting examples of “alkyl” may include methyl, ethyl, n-propyl, isopropyl, n-butyl, isobutyl, sec-butyl, n-pentyl, isopentyl, neopentyl, n-hexyl, 3-methylhexyl, 2,2-dimethylpentyl, 2,3-dimethylpentyl, or n-heptyl.

At least one hydrogen atom of the alkyl group may be substituted with a halogen atom, a C₁-C₂₀ alkyl group substituted with a halogen atom (for example, CCF₃, CHCF₂, CH₂F, or CCl₃), a C₁-C₂₀ alkoxy group, a C₂-C₂₀ alkoxyalkyl group, a hydroxyl group (—OH), a nitro group (—NO₂), a cyano group (—CN), an amino group (—NH₂), an amidino group (—C(═NH)NH₂), a hydrazino group (—NHNH₂), hydrazono group (═N—NH₂), a carboxylic acid group (—C(═O)OH) or a salt thereof (—C(═O)OM) wherein M is an organic or inorganic anion), a sulfonyl group (—S(═O)₂—), a sulfamoyl group (—NH₂SO₂), a sulfonic acid group (—SO₃H₂) or a salt thereof (—SO₃MH or —SO₃M₂ wherein M is an organic or inorganic anion), phosphoric acid (—PO₃H₂) or a salt thereof (—PO₃MH or —PO₃M₂ wherein M is an organic or inorganic anion), a C₁-C₂₀ alkyl group, a C₂-C₂₀ alkenyl group, a C₂-C₂₀ alkynyl group, a C₁-C₂₀ heteroalkyl group, a C₆-C₂₀ aryl group, a C₆-C₂₀ arylalkyl group, a C₆-C₂₀ heteroaryl group, a C₇-C₂₀ heteroarylalkyl group, a C₆-C₂₀ heteroaryloxy group, a C₆-C₂₀ heteroaryloxyalkyl group, or a C₆-C₂₀ heteroarylalkyl group.

The term “halogen” denotes fluorine, bromine, chlorine, or iodine.

The term “alkoxy” refers to an alkyl group linked to an oxygen (“alkyl-O—”). Examples of the alkoxy group may include a methoxy group, an ethoxy group, a 2-propoxy group, a butoxy group, a t-butoxy group, a pentyloxy group, or a hexyloxy group. At least one hydrogen atom of the alkoxy may be optionally substituted with a substituent as described above.

The “alkenyl” refers to a branched or unbranched hydrocarbon having at least one carbon-carbon double bond. Non-limiting examples of the alkenyl group may include vinyl, allyl (H₂C═CH—CH₂—), butenyl, propenyl, or isobutenyl, and optionally, at least one hydrogen atom of the alkenyl may be substituted a substituent as described above.

The “alkynyl” refers to a branched or unbranched hydrocarbon having at least one carbon-carbon triple bond. Non-limiting examples of the alkynyl may include ethynyl, butynyl, isobutynyl, or isopropynyl.

At least one hydrogen atom of the alkynyl may be substituted with the same substituent as the above-described alkyl group.

The term “aryl” means a monovalent group formed by the removal of one hydrogen atom from one or more rings of an arene (e.g., phenyl or napthyl). Non-limiting examples of the aryl may include phenyl, naphthyl, or tetrahydronaphthyl. At least one hydrogen atom of the aryl group may be optionally substituted with a substituent described above.

“Vinyl” group includes any group having terminal unsaturation (—CH₂═CH₂), including acrylate groups (—OC(O)CH═CH₂) and methacrylate (—OC(O)(CH₃)═CH₂) groups.

The “heteroaryl” refers to a monovalent carbocyclic ring group that includes one or more aromatic rings, in which at least one ring member is a heteroatom independently selected from N, O, P, or S with the remainder of the atoms being carbon atoms. In a C3 to C30 heteroaryl, the total number of ring carbon atoms ranges from 3 to 30, with remaining ring atoms being heteroatoms. The S or N may be oxidized to have various oxidation states.

Examples of the heteroaryl may include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, or 5-pyrimidin-2-yl.

“Alkylene” means a straight or branched chain, saturated, divalent aliphatic hydrocarbon group, (e.g., methylene (—CH₂—) or, propylene (—(CH₂)₃—)).

“Alkenylene” means a straight or branched chain, divalent hydrocarbon group having at least one carbon-carbon double bond (e.g., ethenylene (—HC═CH—)).

“Alkynylene” means a straight or branched chain divalent aliphatic hydrocarbon that has one or more unsaturated carbon-carbon bonds, at least one of which is a triple bond (e.g., ethynylene).

“Acid anhydride” refers to a group having two acyl groups joined together by an oxygen atom.

“Hydrocarbon” means an organic compound having at least one carbon atom and at least one hydrogen atom, optionally substituted with one or more substituents where indicated.

The term “heteroaryl” includes a case where a heteroaromatic ring is selectively fused to at least one of aryl, cycloaliphatic, or heterocyclic.

Hereinafter, the present disclosure will be described in more detail with reference to Examples and Comparative Examples. However, these Examples are for illustrating the present disclosure, and the scope of the present disclosure is not limited thereto.

### EXAMPLES

### Examples 1 to 10 and Comparative Examples 1 to 8

Lithium batteries were manufactured according to the components shown in Tables 2 and 3 below. Each of the components was prepared as follows.

### (Preparation of Cathode 1)

LiNi_{0.88}Co_{0.10}Mn_{0.02}O₂ was used as a cathode active material, carbon black was used as a conductive agent, and PVdF was used as a binder. The cathode active material, the conductive agent, and the binder were mixed with N-methylpyrrolidone (NMP) at a weight ratio of 97.7:1:1.1. The resulting mixture was dispersed on an aluminum foil having a thickness of 15 μm at 33 mg/cm² per one side to coat both sides of the aluminum foil with the mixture. The aluminum foil was dried and rolled to prepare cathode 1 having an electrode density of 3.6 g/cc.

### (Preparation of Cathode 2)

LiNi_{0.88}Co_{0.10}Mn_{0.02}O₂ was used as a cathode active material, carbon black was used as a conductive agent, and PVdF was used as a binder. The cathode active material, the conductive agent, and the binder were mixed with N-methylpyrrolidone (NMP) at a weight ratio of 97.7:1:1.1. The resulting mixture was dispersed on an aluminum foil having a thickness of 12 μm at 33.6 mg/cm² per one side to coat both sides of the aluminum foil with the mixture. The aluminum foil was dried and rolled to prepare cathode 1 having an electrode density of 3.6 g/cc.

### (Preparation of Anode 1)

Anode active material SSC-G (an active material designed to exhibit a capacity of 1,300 mAh/g by making secondary particles containing Si of 100 nm in size and carbon-coating the secondary particles with CVD and pitch), graphite, and a binder (AG binder) were mixed with NMP at a weight ratio of 14.7:85.3. The resulting mixture was dispersed on a copper foil having a thickness of 8 μm at 15.6 mg/cm² per one side to coat both sides of the copper foil with the mixture. The copper foil was dried and rolled too prepare anode 1 having an electrode density of 1.65 g/cc.

### (Preparation of Anode 2)

Anode active material SSC-G (an active material designed to exhibit a capacity of 1300 mAh/g by making secondary particles containing Si of 100 nm in size and carbon-coating the secondary particles with CVD and pitch), graphite, and a binder (AG binder) were mixed with NMP at a weight ratio of 14.7:85.33. The resulting mixture was dispersed on a copper foil having a thickness of 8 μm at 15.5 mg/cm² per one side to coat both sides of the copper foil with the mixture. The copper foil was dried and rolled to prepare anode 1 having an electrode density of 1.65 g/cc.

### (Preparation of Electrolyte)

1.15 M LiPF₆ and FEC/EC/EMC/DMC (volume ratio: 3/10/47/40) were used as solvent 1; 1.3 M LiPF₆, FEC/EC/EMC/DMC (volume ratio: 5/20/35/40), and TMP (2 wt %) were used as solvent 2; and 1.3 M LiPF₆, FEC/EC/EMC/DMC (volume ratio: 3/15/12/70) were used as solvent 3. Additives listed in Tables 2 and 3 are added to solvents 1 to 3 to prepare an electrolyte. The structure of each of the additives is shown in Table 1.

TABLE 1

| Abbreviation | Chemical Name | Structure |
|---|---|---|
| PBSN | Propargyl benzenesulfonate | 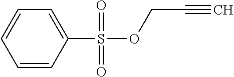 |
| PTSN | Propargyl p-toluenesulfonate | 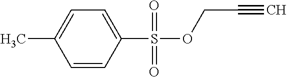 |
| PVSN | Phenyl vinlysulfonate | 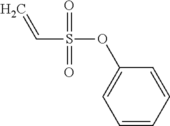 |
| ATSN | Allyl p-toluenesulfonate | 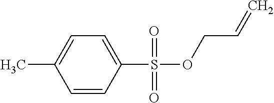 |
| BTSN | 2-Butynyl p-toluenesulfonate | 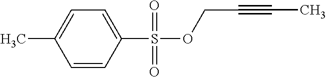 |
| PhpTs | Phenyl p-Toluenesulfonate | 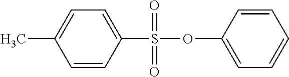 [SMILES: Cc1ccc(S(=O)(=O)Oc2ccccc2)cc1] |
| PMSN | Phenyl methanesulfonate | 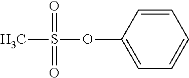 |
| MTSN | Methyl p-toluenesulfonate | 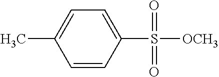 |
| ETSN | Ethyl p-toluenesulfonate | 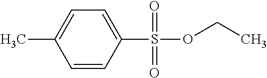 |
| MMDS | Methylene methyl disulfonate | 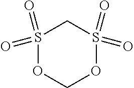 |
| BR11 | Methylene bis(methanesulfonate) | 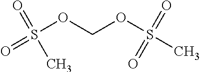 |

### (Assembly of Lithium Battery)

A separator including polypropylene with a thickness of 16 μm was disposed between the cathode and the anode, and the electrolyte was injected into the separator to manufacture a lithium battery.

### Evaluation Example 1: Evaluation of Gas Generation Amount and DC Internal Resistance

Each of the lithium batteries manufactured in Examples 1 to 5 and Comparative Examples 1 to 7 was charged with a current of 0.2 C rate at 25° C. until a voltage reached 3.6 V (vs. Li), and then discharged at a constant current of 0.2 rate until a voltage reached 2.8 V (vs. Li) (formation, 1^{st} cycle). Thereafter, each of the lithium batteries was charged with a current of 0.2 C rate until a voltage reached 4.25 V (vs. Li), and then discharged at a constant current of 0.2 rate until a voltage reached 2.8 V (vs. Li) (formation, 2^{nd} cycle). Third, each of the lithium batteries was charged with a current of 0.5 C rate until a voltage reached 4.25 V (vs. Li), and then cut off at a current of 0.05 C rate while maintaining 4.25 V of a voltage in a constant voltage mode. Then, each of the lithium batteries was discharged at a constant current of 0.2 rate until a voltage reached 2.8 V (vs. Li) (formation, 3^{rd} cycle). Fourth, the third formation process was repeated (0.5 C charging/0.2 C discharging). Finally, each of the lithium batteries was charged with a current of 0.2 C rate until a voltage reached 4.25 V (vs. Li), and then cut off at a current of 0.05 C rate while maintaining 4.25 V of a voltage in a constant voltage mode.

Herein, the 1 C charging means that the battery is charged such that the capacity milliampere-hours (mAh) of the battery may be reached by charging for 1 hour. Similarly, the 1 C discharging means that the battery is discharged such that the capacity (mAh) of the battery may be completely consumed by discharging for 1 hour.

Each of the lithium batteries having been subject to the above formation processes was left at 60° C. for 10 days, and then gas generation amount and internal resistance characteristics were evaluated. The data and results are provided in Table 2.

TABLE 2

| | | | | | Gas generation | | | |
|---|---|---|---|---|---|---|---|---|
| | | | | | amount | 0D | 10D | |
| | Electrolyte | | | | (10D at 60° C.) | DCIR¹ | DCIR¹ | ΔDCIR |
| Ex. | Solvent | additive | Cathode | Anode | [relative value(%)] | (mΩ) | (mΩ) | (%) |
| Example 1 | 1 | 0.5 wt % | 1 | 1 | 0.61 [79%] | 141 | 146 | 104 |
| | | PBSN | | | | | | |
| Example 2 | 1 | 0.5 wt % | 1 | 1 | 0.55 [70%] | 143 | 147 | 103 |
| | | PTSN | | | | | | |
| Example 3 | 1 | 0.5 wt % | 1 | 1 | 0.63 [81%] | 138 | 139 | 100 |
| | | PVSN | | | | | | |
| Example 4 | 1 | 0.5 wt % | 1 | 1 | 0.63 [81%] | 136 | 138 | 102 |
| | | ATSN | | | | | | |
| Example 5 | 1 | 0.5 wt % | 1 | 1 | 0.65 [83%] | 138 | 139 | 101 |
| | | BTSN | | | | | | |
| Comparative | 1 | — | 1 | 1 | 0.78 [100%] | 131 | 132 | 100 |
| Example 1 | | | | | | | | |
| Comparative | 1 | 0.5 wt % | 1 | 1 | 0.72 [92%] | 136 | 140 | 103 |
| Example 2 | | PhpTs | | | | | | |
| Comparative | 1 | 0.5 wt % | 1 | 1 | 0.78 [99%] | 130 | 132 | 102 |
| Example 3 | | PMSN | | | | | | |
| Comparative | 1 | 0.5 wt % | 1 | 1 | 0.71 [90%] | 131 | 135 | 103 |
| Example 4 | | MTSN | | | | | | |
| Comparative | 1 | 0.5 wt % | 1 | 1 | 0.70 [90%] | 130 | 136 | 105 |
| Example 5 | | ETSN | | | | | | |
| Comparative | 1 | 0.5 wt % | 1 | 1 | 0.71 [91%] | 142 | 127 | 90 |
| Example 6 | | MMDS | | | | | | |
| Comparative | 1 | 0.5 wt % | 1 | 1 | 0.77 [98%] | 133 | 128 | 96 |
| Example 7 | | BR11 | | | | | | |

¹milliohms (mΩ).

Referring to Table 2 above, the lithium batteries of Examples 1 to 5 exhibit a significant reduction in the amount of gas generation as compared with the lithium batteries of Comparative Examples 1 to 7. The values of gas generation are normalized to Comparative Example 1. Also, Examples 1 to 5 exhibit a DC internal resistance increase rate at a substantially equal level, and thus exhibit good stability, as compared with the lithium batteries of Comparative Examples 1 to 7.

### Evaluation Example 2: Evaluation of Lifetime Characteristics

Lithium batteries manufactured in Examples 6 to 10 and Comparative Example 8 were respectively charged and discharged at 45° C. during 200 cycles under the conditions of a charge-discharge current of 1 C/1 C, an operation voltage of 2.8 V to 4.3 V, and a cutoff of CC-CV 1/10 C, and then lifetimes and DC internal resistances thereof were measured. The measured data and results are listed in Table 3.

TABLE 3

| | | | | | | | Resistance² | |
|---|---|---|---|---|---|---|---|---|
| | | | | | | Initial | after 200 | |
| | Electrolyte | | | | Lifetime | resistance² | cycles | ΔDCIR |
| Ex. | Solvent | Additive | Cathode | Anode | (%) | (mΩ) | (mΩ) | (%) |
| Example 6 | 1 | 0.5 wt % | 2 | 2 | 80 | 155 | 180 | 116 |
| | | ATSN | | | | | | |
| Example 7 | 2 | 0.6 wt % | 2 | 2 | 83 | 148 | 169 | 114 |
| | | PVSN | | | | | | |
| Example 8 | 2 | 1.0 wt % | 2 | 2 | 82 | 148 | 176 | 119 |
| | | PVSN | | | | | | |
| Example 9 | 2 | 0.6 wt % | 2 | 2 | 83 | 159 | 173 | 109 |
| | | PTSN | | | | | | |
| Example 10 | 3 | 0.5 wt % | 1 | 1 | 83 | 139 | 173 | 124 |
| | | PBSN | | | | | | |
| Comparative | 1 | — | 2 | 2 | 81 | 154 | 180 | 117 |
| Example 8 | | | | | | | | |

²Resistance and initial resistance is listed in milliohms.

Referring to Table 3, the lithium batteries of Examples 6 to 10 exhibit lifetimes and DC internal resistance increase rates at a substantially equal or greater level, and thus exhibit good stability as compared with the lithium battery of Comparative Example 8.

As described above, according to an embodiment, an organic electrolyte including the unsaturated compound is present, and gas reduction characteristics and lifetime characteristics are improved.

It should be understood that embodiments described herein should be considered in a descriptive sense only and not for purposes of limitation. Descriptions of features or aspects within each embodiment should be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A lithium battery comprising:
a cathode;
an anode; and
an electrolyte disposed between the cathode and the anode,
wherein the cathode comprises a cathode active material represented by Formula 1, and the electrolyte comprises a lithium salt, a non-aqueous solvent, and an unsaturated compound represented by Formula 2:
LiₓNi_{y}M_{1-y}O_{2-z}A_{z} Formula 1
wherein, in Formula 1, 0.9≤x≤1.2, 0.7≤y≤0.98, and 0≤z≤0.2,
M is at least one of Al, Mg, Mn, Co, Fe, Cr, V, Ti, Cu, B, Ca, Zn, Zr, Nb, Mo, Sr, Sb, W, or Bi, and
A is an element having an oxidation number of −1, −2, or −3; and 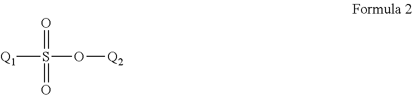
wherein, in Formula 2, one of Q₁ or Q₂ is a group represented by -(L₁)-(R₁), and the other of Q₁ or Q₂ is a group represented by -(L₂)-(R₂),
L₁ is a substituted or unsubstituted C₂-C₂₀ alkenylene group or a substituted or unsubstituted C₂-C₂₀ alkynylene group,
L₂ is a substituted or unsubstituted C₆-C₆₀ arylene group, and
R₁ and R₂ are each independently hydrogen, a substituted or unsubstituted C₁-C₃₀ alkyl group, or a substituted or unsubstituted C₆-C₆₀ aryl group, wherein R₁ and R₂ can be the same or different.

2. The lithium battery of claim 1,
wherein an amount of the unsaturated compound represented by Formula 2 is about 0.005 parts by weight to about 5 parts by weight per 100 parts by weight of the electrolyte.

3. The lithium battery of claim 1,
wherein the unsaturated compound is represented by Formula 3 or Formula 4, 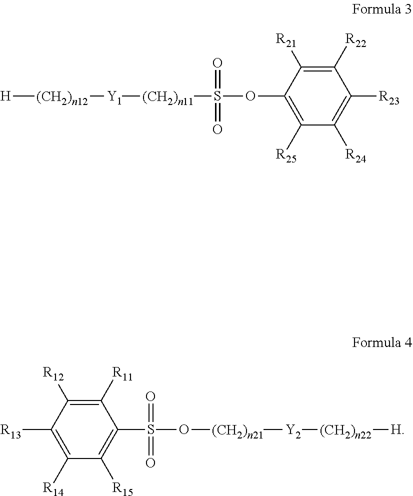
wherein, in Formulae 3 and 4,
n11, n12, n21, and n22 are each independently an integer of 0 to 5,
Y₁ and Y₂ are each independently —CH═CH— or —C═C—, and
R₁₁ to R₁₅ and R₂₁ to R₂₅ are each independently hydrogen, a methyl group, an ethyl group, a propyl group, an isopropyl group, a butyl group, a sec-butyl group, a tert-butyl group, or an isobutyl group.

4. The lithium battery of claim 3,
wherein, in Formulae 3 and 4,
each of n12 and n22 is 0, and
at least one of R₁₁ to R₁₅ or at least one of R₂₁ to R₂₅, is a methyl group, an ethyl group, a propyl group, an isopropyl group, a butyl group, a sec-butyl group, a tert-butyl group, or an isobutyl group.

5. The lithium battery of claim 1,
wherein the unsaturated compound is at least one of Compound 1, Compound 2, Compound 3, Compound 4, Compound 5, Compound 6, Compound 7, Compound 8, Compound 9, Compound 10, Compound 11, Compound 12, or Compound 13,

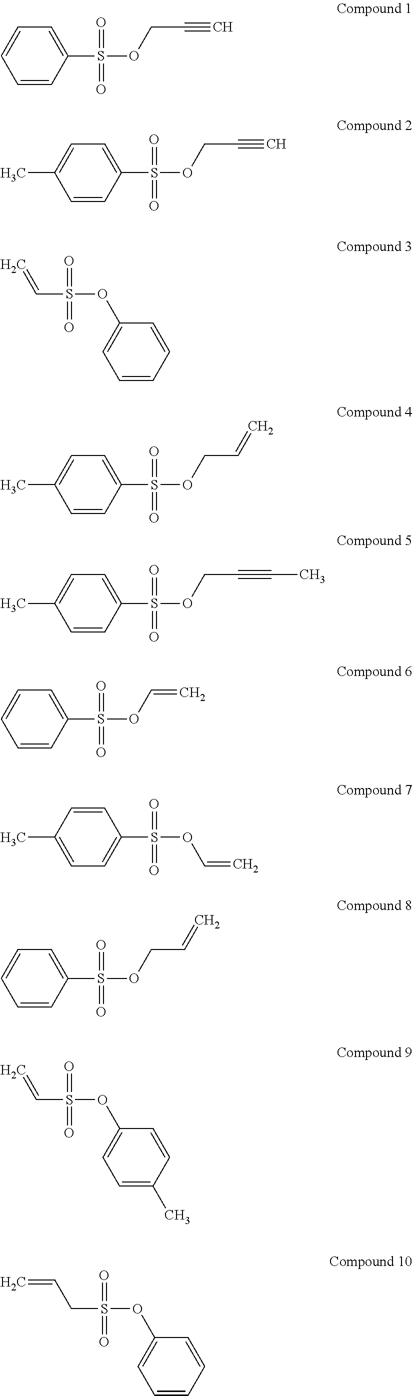

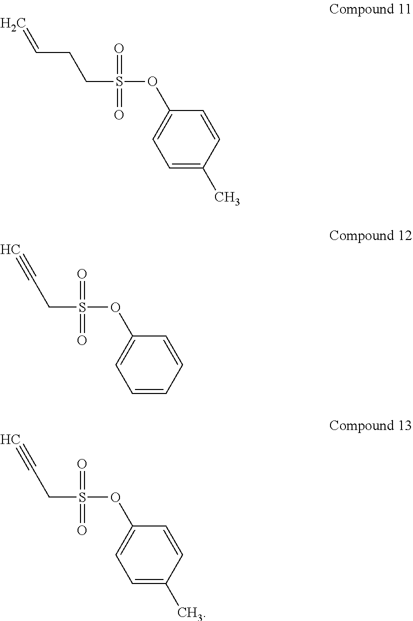

6. The lithium battery of claim 1,
wherein the lithium salt comprises at least one of LiPF₆, LiBF₄, LiCF₃SO₃, Li(CF₃SO₂)₂N, LiC₂F₅SO₃, Li(FSO₂)₂N, LiC₄F₉SO₃, LiN(SO₂CF₂CF₃)₂, a compound represented by Formula 22, a compound represented by Formula 23, a compound represented by Formula 24, or a compound represented by Formula 25:

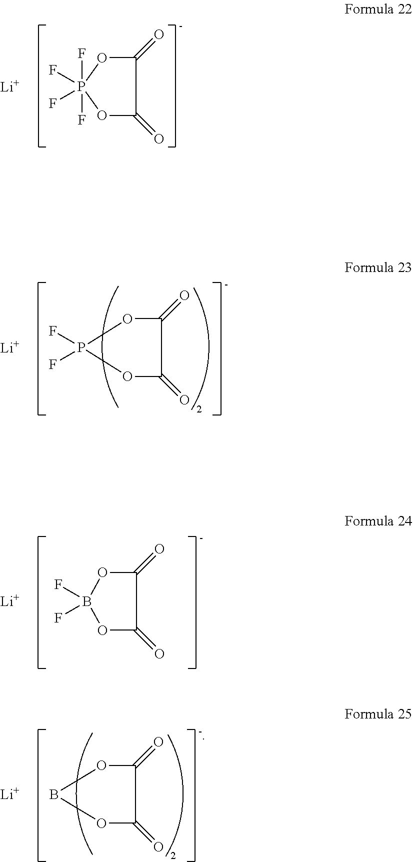

7. The lithium battery of claim 1,
wherein a concentration of the lithium salt in the electrolyte is about 1.0 moles per liter to about 1.5 moles per liter.

8. The lithium battery of claim 1, wherein the non-aqueous solvent comprises dimethyl carbonate, diethyl carbonate, ethyl methyl carbonate, dipropyl carbonate, methyl propyl carbonate, ethyl propyl carbonate, methyl ethyl carbonate, ethylene carbonate, propylene carbonate, butylene carbonate, methyl propionate, ethyl propionate, propyl propionate, tetraethylene glycol dimethyl ether, or a combination thereof.

9. The lithium battery of claim 1,
wherein the electrolyte further comprises a cyclic carbonate compound, a cyclic acid anhydride compound, a phosphorus containing compound, a sulfur containing compound, or a combination thereof.

10. The lithium battery of claim 9,
wherein the phosphorus-containing compound is at least one of a phosphine compound, a phosphate compound, or a phosphite compound, and
the sulfur-containing compound is at least one of a sulfone compound, a sulfonate compound, a sultone compound, or a disulfonate compound.

11. The lithium battery of claim 9,
wherein the cyclic carbonate compound, the cyclic acid anhydride compound, or the combination thereof, is present in an amount of about 0.1 parts by weight to about 2 parts by weight, per 100 parts by weight of the electrolyte.

12. The lithium battery of claim 9,
wherein the cyclic carbonate compound comprises at least one of fluoro-ethylene carbonate, vinylene carbonate, or vinyl ethylene carbonate, and
the cyclic acid anhydride compound comprises at least one of maleic anhydride or succinic anhydride.

13. The lithium battery of claim 1,
wherein M, in Formula 1, is at least one of Co, Al, or Mn.

14. The lithium battery of claim 1,
wherein the cathode active material is represented by Formula 30 or Formula 40
Li_{x′}Ni_{y′}Co_{1-y′-z′}Al_{z′}O₂ Formula 30
Li_{x′}Ni_{y′}Co_{1-y′-z′}Mn_{z′}O₂, Formula 40
wherein, in Formula 30 and Formula 40, 0.9≤x′≤1.2, 0.88≤y′≤0.98, 0<z′<0.1, and 0<1-y′-z′<0.2.

15. The lithium battery of claim 1,
wherein the cathode comprises at least one of Li_{1.02}Ni_{0.80}Co_{0.15}Mn_{0.05}O₂, Li_{1.02}Ni_{0.85}Co_{0.1}Mn_{0.05}O₂, Li_{1.02}Ni_{0.88}Co_{0.08}Mn_{0.04}O₂, Li_{1.02}Ni_{0.88}Co_{0.10}Mn_{0.02}O₂, Li_{1.02}Ni_{0.91}Co_{0.06}Mn_{0.03}O₂, LiNi_{0.94}Co_{0.04}Mn_{0.02}O₂, Li_{1.02}Ni_{0.80}Co_{0.15}Al_{0.05}O₂, Li_{1.02}Ni_{0.85}Co_{0.1}Al_{0.05}O₂, Li_{1.02}Ni_{0.88}Co_{0.08}Al_{0.04}O₂, Li_{1.02}Ni_{0.88}Co_{0.10}Al_{0.02}O₂, Li_{1.02}Ni_{0.91}Co_{0.06}Al_{0.03}O₂, or LiNi_{0.94}Co_{0.04}Al_{0.0202}.

16. The lithium battery of claim 1,
wherein the anode comprises an anode active material, and
the anode active material comprises at least one of a silicon compound, a carbon compound, a composite of a silicon compound and a carbon compound, or a silicon oxide.

17. The lithium battery of claim 16,
wherein the anode active material comprises a silicon compound or a silicon oxide, and
the silicon compound comprises silicon particles having an average particle diameter of about 200 nm or less.

18. The lithium battery of claim 1,
wherein the lithium battery has a capacity retention rate of about 75% or greater after 200 cycles of charge and discharge at 25° C.

19. The lithium battery of claim 1,
wherein the lithium battery has a direct current internal resistance (DCIR) of about 180% or less after 200 cycles of charging and discharging at 25° C.

20. The lithium battery of claim 1,
wherein the lithium battery has a cell energy density of 500 Watt-hours per liter or more.
